(19) United States
(12) Patent Application Publication
(10) Pub. No.: US 2007/0026269 A1
(43) Pub. Date: Feb. 1, 2007

(54) Relief valve, method of manufacturing relief valve, and fuel cell

(75) Inventor: Toru Nakakubo, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/486,090

(22) Filed: Jul. 14, 2006

(30) Foreign Application Priority Data
Jul. 29, 2005 (JP) 2005-222099

(51) Int. Cl. H01M 8/00

(52) U.S. Cl. 429/13

(57) ABSTRACT

Provided is a relief valve that is small in size and has a simple structure in which a flow path is provided so as to penetrate a diaphragm or a support portion of the diaphragm, and an outlet is located at an opposite side of an inlet through the diaphragm. The relief valve for pressure adjustment is made of a semiconductor wafer and operates in a case where a pressure at a fluid inlet is higher than a pressure at a fluid outlet by a pressure higher than a set pressure value, the relief valve including a flow path communicating the fluid inlet with the fluid outlet and a diaphragm for opening and closing the flow path by deformation utilizing a differential pressure between the fluid inlet and the fluid outlet, wherein the flow path penetrates the diaphragm or is disposed at a side surface of the diaphragm, the diaphragm and the valve seat are in contact with each other, and the flow path is opened and closed by deformation of the diaphragm.

### BACKGROUND OF THE INVENTION

1. Field of the Invention

The present invention relates to a relief valve that is manufactured by using a semiconductor processing technology, a method of manufacturing the relief valve, and a fuel cell. Specifically, the present invention relates to a relief value having a direct acting type diaphragm, and a small-sized polymer electrolyte membrane fuel cell having the relief valve mounted thereon and several milliwatts to several hundreds watts in power generation, which can be mounted on a small electric instrument.

2. Related Background Art

Up to now, various types of relief valves have been manufactured by using a mechanical processing technology. Those relief values are roughly classified into a direct acting type and a pilot type. The direct acting type has an advantage that a structure thereof is simpler than that of the pilot type. Also, the direct acting type is frequently used in a case where an operating fluid is a gas because the direct acting type operates utilizing a minute differential pressure. However, because the direct acting type operates excessively sensitively to the pressure, there may generate a chattering phenomenon that a valve member vibrates depending on a use pressure region. Also, a poppet, a diaphragm, or a bellows has been used for a pressure-sensitive portion. Above all, the diaphragm has been frequently used to operate the relief valve utilizing a minute differential pressure. Japanese Patent Application Laid-Open No. H06-94147 discloses an example of a direct acting type relief valve using the diaphragm. In Japanese Patent Application Laid-Open No. H06-94147, the differential pressure is sensed by the diaphragm, and the valve member operates after the diaphragm is apart from a valve seat.

Also, Japanese Patent Application Laid-Open No. S64-64609 discloses a relief valve as an example of diaphragm-direct acting type relief valves in which the diaphragm having a flow path is deformed by the differential pressure to control the fluid.

On the other hand, the various minute mechanical elements have been manufactured by using the semiconductor processing technology. The semiconductor processing technology has a feature that the minute processing of submicron order can be performed and the mass production is easily realized by using a batch process. H. Jerman, “J. Micromech. Microeng.”, 4, 210-216, 1994 discloses an active driven microvalve that has been manufactured by using a plurality of semiconductor substrates (silicon material) and a semiconductor processing technology.

Attention has been focused on a small-sized fuel cell as an energy source that is mounted on a small-sized electric instrument. The fuel cell is useful as a driving source of the small-sized electric device because an energy amount which can be supplied per volume or weight is several times to ten times as much as that of a conventional lithium ion secondary battery. In particular, in order to obtain a large output, use of hydrogen as a fuel for a fuel cell is optimum. However, there is required a method of storing hydrogen in a small-sized fuel tank with a high density because hydrogen is a gas at a room temperature.

A first method is a method of compressing hydrogen and saving the hydrogen as a high pressure gas. When a pressure of the gas within a tank is set to 200 atmospheric pressures, the volume hydrogen density becomes about 18 mg/cm³. A second method is a method of reducing a temperature of hydrogen and storing the hydrogen as liquid. In a case of liquefying hydrogen, there arise problems in that a large energy is required and liquefied hydrogen is naturally gasified and leaked. However, storage of hydrogen with a high density can be performed. A third method is a method of storing hydrogen by using a metal hydride. In the method, it is possible to occlude hydrogen of about 2% by weight of metal hydride.

On the other hand, the power generation of a polymer electrolyte membrane fuel cell is conducted in the following manner. Perfluoro sulfonic acid-based cationic exchange resin is frequently used for a polymer electrolyte membrane. For example, Nafion made by DuPont Corp. is well known as the membrane. A membrane electrode assembly in which the proton exchange membrane is held between a pair of porous electrodes that carry a catalyst such as platinum, that is, a fuel electrode and an oxidizer electrode becomes a power generation cell. An oxidizer is supplied to the oxidizer electrode, and a fuel is supplied to the fuel electrode with respect to the power generation cell, to thereby move ions in the polymer electrolyte membrane and generate a power.

The polymer electrolyte membrane having a thickness of about 50 to 100 μm is normally used in order to keep the mechanical strength and prevent a fuel from penetrating the membrane. The strength of the proton exchange membrane is about 300 to 500 kPa (3 to 5 kg/cm²). Accordingly, it is preferable that a difference pressure between an oxidizer electrode chamber and a fuel electrode chamber of the fuel cell be set to about 50 kPa (0.5 kg/cm²) at a normal time and 100 kPa (1 kg/cm²) or lower at an abnormal time in order to prevent break of the membrane due to the differential pressure.

Under the circumstances, in a case where the pressure within the fuel electrode chamber is higher than the above-mentioned pressure, the pressure within the electrode chamber must be lowered in order to prevent the break of the polymer electrolyte membrane. Japanese Patent Application Laid-Open No. 10-284098 discloses a mechanism in which a relief valve is disposed in a fuel flow path of the fuel cell and a fuel gas is discharged to the outside in a case where the pressure within the flow path becomes higher than a set pressure, to thereby prevent the system from being damaged.

A conventional mechanical processing technique/assembling technique do not have enough precision to fabricate a super-small relief valve, so it is very difficult to manufacture the super-small relief valve. Also, there arises a problem of high manufacturing costs.

Also, there is no relief valve among the microvalve types that are fabricated by using the conventional semiconductor processing technique. In particular, the relief valve has a structure in which an inlet and an outlet are present in the same direction, but does not have a structure in which the outlet is at the opposite side of the inlet or at the lateral side of the inlet through the diaphragm. For this reason, in a case where a direction of the flow path after the outlet is desired to be led to a direction different from the inlet with respect to the diaphragm, there arises a problem in that the structure becomes complicated. Also, the microvalve formed by using the conventional semiconductor processing technique is manufactured to be the active driving type in many cases, and does not have a structure which can perform an optimum pressure setting as a relief valve.

### SUMMARY OF THE INVENTION

The present invention has been accomplished in view of the above-mentioned background art, and has an object of providing a relief valve that is made of a semiconductor wafer and very small by manufacturing with the use of a semiconductor processing technology.

Another object of the present invention is to provide a relief valve that is small in size and simple in structure and has an outlet disposed at an opposite side of an inlet through a diaphragm by providing a flow path through the diaphragm or a support portion of the diaphragm.

Another object of the present invention is to provide a method of manufacturing a relief valve for pressure adjustment which significantly suppresses leakage from a gap between semiconductor wafer members by joining the semiconductor wafer members with each other to manufacture the valve.

Another object of the present invention is to provide a fuel cell capable of supplying a fuel gas from a fuel tank to a fuel cell unit while keeping the pressure of the fuel gas constant by mounting the above-described relief valve on the small-sized fuel cell.

That is, according to one aspect of the present invention, there is provided a relief valve for pressure adjustment which is made of a semiconductor wafer and operates in a case where a pressure at a fluid inlet is higher than a pressure at a fluid outlet by a pressure higher than a set pressure value, the relief valve including:

a flow path communicating the fluid inlet with the fluid outlet; and

a diaphragm for opening and closing the flow path by deformation of the diaphragm utilizing a differential pressure between the fluid inlet and the fluid outlet.

It is preferable that the flow path is provided so as to penetrate the diaphragm or a support portion for supporting the diaphragm.

It is preferable that the flow path is provided so as to penetrate the diaphragm, the diaphragm and a valve seat are provided so as to be in contact with each other, and a constant state and a non-contact state of the diaphragm with the valve seat are switched by deformation of the diaphragm.

It is preferable that the flow path is provided so as to penetrate the support portion for supporting the diaphragm, the support portion and a valve seat are provided so as to be in contact with each other, and a contact state and a non-contact state of the support portion with the valve seat are switched by deformation of the diaphragm.

It is preferable that the support portion for supporting the diaphragm is a valve member.

It is preferable that the flow path is provided so as to penetrate a part of the support portion for supporting the diaphragm, another part of the support portion and a valve seat are provided so as to be in contact with each other, and a contact state and a non-contact of the another part of the support portion with the valve seat are switched by deformation of the diaphragm.

It is preferable that the another part of the support portion for supporting the diaphragm is a valve member.

It is preferable that the differential pressure between the fluid inlet and the fluid outlet is adjusted by causing bending or stress in-the diaphragm.

According to another aspect of the present invention, there is provided a method of manufacturing a relief valve for pressure adjustment which includes a flow path communicating a fluid inlet with a fluid outlet, and a diaphragm for opening and closing the flow path by deformed of the diaphragm utilizing a differential pressure between the fluid inlet and the fluid outlet, the relief valve operating in the case where a pressure at the fluid inlet is higher than a pressure at the fluid outlet by a set pressure value or more, the method including the steps of:

forming the diaphragm and the flow path in a semiconductor wafer; and

forming the flow path in a substrate.

It is preferable that the method of manufacturing the relief valve further include the step of forming a valve member in the semiconductor wafer.

It is preferable that the method of manufacturing the relief valve further include the step of forming a valve seat in the substrate.

It is preferable that the method of manufacturing the relief valve further include the step of bonding the semiconductor wafer and the substrate.

It is preferable that the method of manufacturing the relief valve further include the steps of:

forming a sacrifice layer before bonding the semiconductor wafer and the substrate; and

removing the sacrifice layer after bonding the semiconductor wafer and the substrate.

It is preferable that the method of manufacturing the relief valve further include the step of forming a thin film on a surface of the diaphragm.

It is preferable that the method of manufacturing the relief valve further include the step of modifying or coating the surface of the relief valve.

It is preferable that the substrate is made of a semiconductor wafer.

According to another aspect of the present invention, there is provided a fuel cell including the relief valve described above.

According to the present invention, there can be provided the relief valve that is small in the size and has the simple structure, which is made of the semiconductor wafer and has the outlet at the opposite side of the inlet through the diaphragm by arranging the flow path through the diaphragm or the support portion of the diaphragm.

Also, there can be provided a method of manufacturing the small-sized relief valve by manufacturing the valve using the semiconductor processing technology.

Further, according to the present invention, there can be provided a method of manufacturing a relief valve for pressure adjustment which significantly suppress the leakage from the gap between semiconductor wafer members by joining the members with each other to manufacture the valve.

Further, according to the present invention, there can be provided the fuel cell capable of supplying the fuel gas from the fuel tank to the fuel cell while keeping the pressure of the fuel gas constant by mounting the relief valve on the small-sized fuel cell.

### BRIEF DESCRIPTION OF THE DRAWINGS

FIGS. 1A and 1B are cross-sectional views showing a relief valve according to an embodiment of the present invention;

FIGS. 2A, 2B, and 2C are cross-sectional views showing a relief valve according to another embodiment of the present invention;

FIGS. 3A, 3B, and 3C are schematic views showing the relief value of the present invention which has been manufactured by using a mechanical processing technology;

FIGS. 4A, 4B, 4C, 4D, 4E, 4F, 4G, 4H, 4I, 4J, 4K, 4L, 4M, 4N, 4O, 4P, and 4Q are process step views showing a method of manufacturing a relief valve according to Example 1 of the present invention;

FIGS. 5A, 5B, 5C, 5D, 5E, 5F, 5G, 5H, 5I, 5J, and 5K are process step views showing a method of manufacturing a relief valve according to Example 2 of the present invention;

FIGS. 6A, 6B, 6C, 6D, 6E, 6F, 6G, and 6H are process step views showing a method of manufacturing a relief valve according to Example 3 of the present invention;

FIGS. 7A, 7B, 7C, 7D, 7E, 7F, and 7G are process step views showing a method of manufacturing a relief valve according to Example 4 of the present invention;

FIG. 8 is a perspective view showing a fuel cell according to the present invention;

FIG. 9 is a schematic diagram showing a system of the fuel cell according to the present invention;

FIG. 10 is a schematic diagram showing a second system of the fuel cell according to the present invention; and

FIGS. 11A and 11B are a plan view and a cross-sectional view of a seal surface of the relief valve according to the present invention, respectively.

### DESCRIPTION OF THE PREFERRED EMBODIMENTS

A relief valve according to the present invention is a relief valve for pressure adjustment which operates in the case where a pressure in an inlet of a fluid is higher than a pressure in an outlet of the fluid by a pressure higher than a set pressure value, which is characterized by including a flow path communicating the inlet of the fluid with the outlet of the fluid, and a diaphragm for opening and closing the flow path by deformation of the diaphragm utilizing a pressure difference between the inlet and the outlet of the fluid.

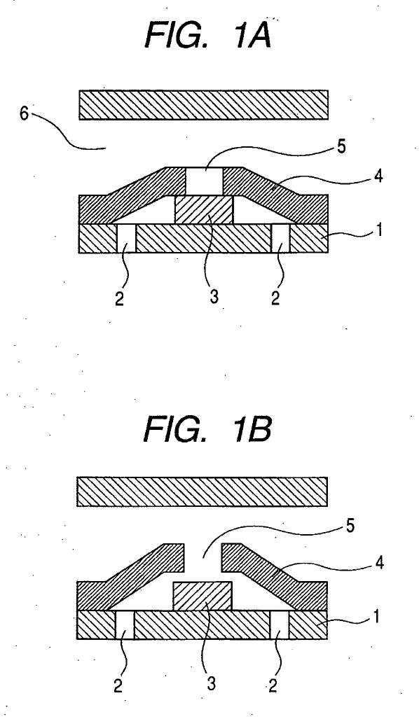

Hereinafter, a description will be given of the structure of the relief valve according to the present invention with reference to the accompanying drawings. FIGS. 1A and 1B are cross-sectional views showing a relief valve according to an embodiment of the present invention. FIG. 1A shows a state in which the valve is closed, and FIG. 1B shows a state in which the valve is opened. In the relief valve shown in FIGS. 1A and 1B, the flow path penetrates the diaphragm, and the diaphragm and a valve seat are provided so as to bring them in contact with each other, and the diaphragm is deformed to open or close the flow path. Referring to FIG. 1A, a diaphragm 4 is disposed between a fluid inlet 2 and a fluid outlet 6, and a flow path 5 penetrates the diaphragm 4. The flow path 5 is closed by pushing the diaphragm 4 against a valve seat 3. In the case where the pressure in the fluid inlet 2 exceeds the pressure in the fluid outlet 6 by a pressure higher than a set value, the diaphragm 4 is pushed up toward the fluid outlet side and deformed. As a result, a gap can be generated between the valve seat 3 and the diaphragm 4, and the fluid flows into the fluid outlet 6 from the fluid inlet 2 (FIG. 1B). On the other hand, in the case where the pressure in the fluid inlet 2 is higher than the pressure in the fluid outlet 6 by a pressure of the set value or lower, the diaphragm 4 is seated, the diaphragm 4 is pushed against the valve seat 3 (FIG. 1A), and a flowing of the fluid stops.

A first method of setting an open pressure of the valve is that the thickness of the valve seat 3 is adjusted to bend the diaphragm in advance. Also, a second method of setting the open pressure is that the diaphragm is made of a material having an internal stress. Also, the response of the valve is determined according to the material, the thickness, or the diameter of the diaphragm.

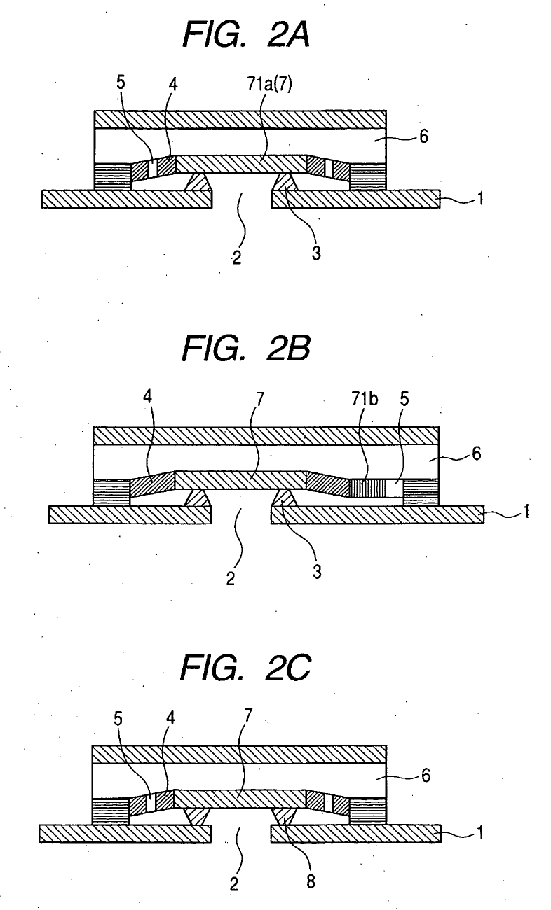

FIGS. 2A to 2C are cross-sectional views showing a relief valve according to another embodiment of the present invention. FIGS. 2A to 2C show a state in which the valve is closed. In the relief valve shown in FIG. 2A, the diaphragms 4 are supported at both sides of the valve member 7 that is a support portion 71a. In this case, it is preferable that the valve member 7 and the diaphragm 4 are integrated together. Each of the diaphragms 4 that is formed at both sides of the valve member 7 is disposed between the fluid inlet 2 and the fluid outlet 6, and the flow path 5 penetrates the diaphragm 4. The valve member 7 that is integrated with the diaphragm 4 is pushed against the valve seat 3 to block the fluid. In the case where the pressure in the fluid inlet is higher than the pressure in the fluid outlet by a pressure higher than the set value, the diaphragm 4 is pushed up toward the fluid outlet side and deformed. As a result, a gap can be generated between the valve member 7 and the valve seat 3, and the fluid passes through the flow path 5 that penetrates the diaphragm 4, and flows from the fluid inlet to the fluid outlet. On the other hand, in the case where the pressure in the fluid inlet is higher than the pressure in the fluid outlet by the set value or lower, the diaphragm 4 is seated, and the valve member 7 is pushed against the valve seat 3 to stop the circulation of fluid.

Also, the relief valve shown in FIG. 2B is a case in which the flow path is disposed outside the diaphragm. The flow path 5 penetrates the support portion 71b that supports the diaphragm 4, and the same operation as that of FIG. 2A is conducted to deform the diaphragm, whereby the flow path is opened or closed.

Also, in the relief valve shown in FIG. 2C, the value member 7 that is integrated with the diaphragm 4 has a projection portion 8. In this case, the same operation as that in FIG. 2A is conducted to deform the diaphragm by utilizing a pressure difference that is applied to both surfaces of the diaphragm, whereby the flow path is opened or closed.

### EXAMPLES

The present invention will be described hereinafter based on examples as described below.

### Comparative Example 1

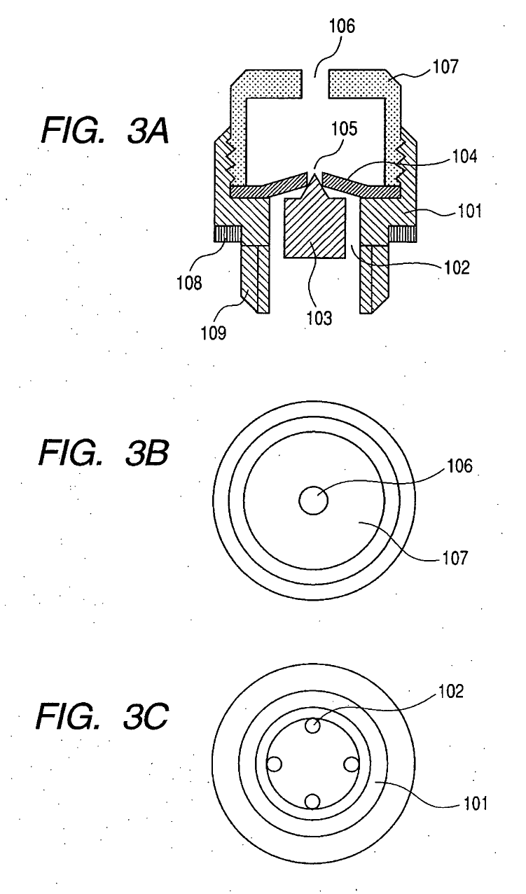

First, a description will be given of the structure in the case of fabricating a relief valve by using a mechanical processing technique as a comparative example. FIGS. 3A to 3C are schematic views showing the relief valve of the present invention which is fabricated by the mechanical processing technique. FIG. 3A is a cross-sectional view, FIG. 3B is a plan view, and FIG. 3C is a bottom surface view. A substrate 101 has a fluid inlet 102 and a valve seat 103. Used as a material for the substrate is a metal material such as stainless steel or aluminum, or a plastic material such as acrylic resin.

The diaphragm 104 is made of an elastic material, and a flow path 105 is formed in the center of the diaphragm 104. The diaphragm is made of a plastic material such as fluororubber, silicone rubber, or urethane rubber, or a metal material such as stainless steel, phosphor bronze, or beryllium. In the case of using the metal material, it is possible to shape the diaphragm in a wave configuration in order to obtain a large displacement by a smaller force.

After the diaphragm 104 has been located on the substrate 101, the diaphragm 104 is fixed by a cap 107 having the fluid outlet 106. The relief valve thus assembled is attached to the flow path by a screw portion 109. The screw portion 109 provided with a seal 108 prevents the fluid from being leaked to the external through the screw portion 109. The seal 108 is made of silicone rubber or fluororubber.

In the case of using the metal material for the diaphragm 104, it is possible to use a member made of a rubber material such as silicone rubber and fluororubber for a portion which is in contact with the valve seat 103 in order to enhance sealing property. On the other hand, in the case where the diaphragm 104 is made of a rubber material, it is possible to reinforce a back surface of a diaphragm portion that is in contact with the valve seat 103 by a rigid material such as a metal.

The operating pressure p of the relief valve is determined according to an initial bending ω, a material, a radius r, a thickness h of the diaphragm 104. Those relationships substantially comply with the following expression (1). In the expression, E is Young's modulus, and m is a Poisson ratio.

$$ω = \frac{{pr}^{4}}{64 D} \\ where D is \\ D = \frac{{m}^{2} {Eh}^{2}}{12 ( {m}^{2} - 1 )} \qquad ( 1 )$$

Table 1 expresses a differential pressure (cracking pressure) between the fluid inlet and the fluid outlet when the relief valve is opened in the case where the material (stainless steel (SS), aluminum (Al), silicon (Si) and silicone), the diameter, the thickness, and the initial bending (precompression bending) are changed.

TABLE 1

| | | | | | Bending | |
|---|---|---|---|---|---|---|
| | | | Clacking | Precompression | amount | |
| Material | Diameter | Thickness | pressure | bending | [m]/ | Natural |
| name | [mm] | [mm] | [Pa (G)] | [m] | 10 kPa | frequency [Hz] |
| SS | 4.00 | 0.10 | 2.00E+05 | 2.71E−06 | 1.36E−07 | 9.60E+06 |
| SS | 4.00 | 0.20 | 2.00E+05 | 3.39E−07 | 1.70E−08 | 1.92E+07 |
| SS | 6.00 | 0.10 | 2.00E+05 | 1.37E−05 | 6.87E−07 | 4.27E+06 |
| Al | 4.00 | 0.10 | 2.00E+05 | 7.58E−06 | 3.79E−07 | 9.89E+06 |
| Al | 4.00 | 0.20 | 2.00E+05 | 9.48E−07 | 4.74E−08 | 1.98E+07 |
| Al | 6.00 | 0.10 | 2.00E+05 | 3.84E−05 | 1.92E−06 | 4.39E+06 |
| Si | 4.00 | 0.03 | 2.00E+05 | 2.12E−04 | 1.06E−05 | 4.03E+06 |
| Si | 4.00 | 0.05 | 2.00E+05 | 2.65E−05 | 1.32E−06 | 8.05E+06 |
| Si | 6.00 | 0.03 | 2.00E+05 | 1.07E−03 | 5.36E−05 | 1.79E+06 |
| Silicone | 4.00 | 0.10 | 2.00E+05 | 9.67E−02 | 4.83E−03 | 1.31E+05 |
| Silicone | 4.00 | 0.20 | 2.00E+05 | 1.21E−02 | 6.04E−04 | 2.63E+05 |
| Silicone | 6.00 | 0.10 | 2.00E+05 | 4.89E−01 | 2.45E−02 | 5.84E+04 |
| Silicone | 5.00 | 0.30 | 5.00E+04 | 2.19E−03 | 4.37E−04 | 2.52E+05 |
| Silicone | 5.00 | 0.50 | 5.00E+04 | 4.72E−04 | 9.44E−05 | 4.20E+05 |

As described above, it is possible to change the operating pressure by giving the initial bending to the diaphragm in advance. Also, the table shows the amount of displacement of the diaphragm in the case where the differential pressure between the both sides of the diaphragm is 10 kPa. The amount of displacement of the valve increases more as the differential pressure becomes larger.

On the other hand, the flow rate of a fluid that passes through the valve when the valve is opened is determined according to the flow path diameter, the amount of displacement of the diaphragm, and the differential pressure between the fluid inlet and the fluid outlet. A change in the flow rate Q depending on the displacement of the diaphragm and the differential pressure between the fluid inlet and the fluid outlet is expressed by the following expression (2):

$$D = \frac{π {dx}^{3}}{12 μ ( {d}_{2} - {d}_{1} )} ⨯ \frac{{P}_{1}^{2} - {P}_{0}^{2}}{{P}_{0}} \qquad ( 2 )$$

wherein d₁ is a hole diameter of the diaphragm, d₂ is a valve seat diameter, d is a mean of the diaphragm hole diameter and the valve seat diameter, P₁ is an inlet side pressure, P₀ is an outlet side pressure, μ is viscosity, and x is the displacement.

Table 2 shows the flow rate of a fluid that passes through the valve when the amount of displacement of the diaphragm is changed. Also, the flow rate becomes larger as the amount of displacement of the diaphragm becomes larger, and as the differential pressure becomes larger.

TABLE 2

| Diaphragm | Valve | | | | |
|---|---|---|---|---|---|
| hole | seat | Inner | Outer | Displace- | Flow |
| diameter | diameter | pressure | pressure | ment | rate |
| d₁ [mm] | d₂ [mm] | P₁ [Pa] | P₀ [Pa] | x [μm] | [m³/s] |
| 1.00 | 2.00 | 4.00E+05 | 1.00E+05 | 1.00E+00 | 8.92E−08 |
| 1.00 | 2.00 | 4.00E+05 | 1.00E+05 | 2.00E+00 | 7.14E−07 |
| 1.00 | 2.00 | 4.00E+05 | 1.00E+05 | 3.00E+00 | 2.41E−06 |
| 1.00 | 2.00 | 4.00E+05 | 1.00E+05 | 4.00E+00 | 5.71E−06 |
| 1.00 | 2.00 | 4.00E+05 | 1.00E+05 | 5.00E+00 | 1.12E−05 |
| 1.00 | 2.00 | 1.50E+05 | 1.00E+05 | 1.00E+00 | 7.43E−09 |
| 1.00 | 2.00 | 1.50E+05 | 1.00E+05 | 2.00E+00 | 5.95E−08 |
| 1.00 | 2.00 | 1.50E+05 | 1.00E+05 | 3.00E+00 | 2.01E−07 |
| 1.00 | 2.00 | 1.50E+05 | 1.00E+05 | 4.00E+00 | 4.76E−07 |
| 1.00 | 2.00 | 1.50E+05 | 1.00E+05 | 5.00E+00 | 9.29E−07 |
| 0.50 | 2.00 | 4.00E+05 | 1.00E+05 | 1.00E−01 | 5.95E−11 |
| 0.50 | 2.00 | 4.00E+05 | 1.00E+05 | 2.00E+00 | 4.76E−07 |
| 0.50 | 2.00 | 4.00E+05 | 1.00E+05 | 3.00E+00 | 1.61E−06 |
| 0.50 | 2.00 | 4.00E+05 | 1.00E+05 | 4.00E+00 | 3.81E−06 |
| 0.50 | 2.00 | 4.00E+05 | 1.00E+05 | 5.00E+00 | 7.43E−06 |
| 0.50 | 2.00 | 1.50E+05 | 1.00E+05 | 1.00E+00 | 4.96E−09 |
| 0.50 | 2.00 | 1.50E+05 | 1.00E+05 | 2.00E+00 | 3.96E−08 |
| 0.50 | 2.00 | 1.50E+05 | 1.00E+05 | 3.00E+00 | 1.34E−07 |
| 0.50 | 2.00 | 1.50E+05 | 1.00E+05 | 4.00E+00 | 3.17E−07 |
| 0.50 | 2.00 | 1.50E+05 | 1.00E+05 | 5.00E+00 | 6.19E−07 |

The maximum flow rate Q of the valve is determined according to the sizes of the flow path 105 by the following expression (3):
Q=CdA√(2÷ρ×ΔP) (3)
wherein Cd is the coefficient of flow rate (normally 0.7), ρ is fluid density, ΔP is the differential pressure before and after the flow path, and A is a cross-sectional area of the flow path.

Table 3 shows a change in the maximum flow rate by changing to the differential pressure between the fluid inlet and the fluid outlet when the diameter of the flow path 105 is changed.

TABLE 3

| Flow | Differential | Hole |
|---|---|---|
| rate | pressure | diameter |
| [m³/s] | [Pa] | [m] |
| 1.67 × 10⁻⁸ | 50000 | 3.02 × 10⁻⁴ |
| (100[ccm]) | 300000 | 1.93 × 10⁻⁴ |
| 1.67 × 10⁻⁷ | 50000 | 9.55 × 10⁻⁴ |
| (1000[ccm]) | 300000 | 6.10 × 10⁻⁴ |
| 1.67 × 10⁻⁶ | 50000 | 3.02 × 10⁻³ |
| (10000[ccm]) | 300000 | 1.93 × 10⁻³ |

The response speed of the valve is determined according to the natural frequency of the diaphragm 104. As the natural frequency of the valve is larger, the response becomes faster to improve the sensitivity. However, there is a possibility that a problem such as chattering occurs. When it is assumed that the mass of the diaphragm 104 is m, and the spring constant is k, the natural frequency is expressed by ω=√(k/m). Table 1 shows the natural frequency in the case where the material and size of the diaphragm 104 are changed.

The maximum stress (σ_{MAX}) that is applied to the diaphragm 104 is expressed by the following expression (4).

$${σ}_{max} = \frac{3}{4} {( \frac{r}{h} )}^{2} p \qquad ( 4 )$$

wherein r is the radius of the diaphragm, h is the thickness of the diaphragm, and p is a pressure. The material and dimensions of the diaphragm are determined under a condition that the valve is not damaged in a use pressure range according to the above expression.

### Example 1

A description will be given of the first method of manufacturing the relief valve of the present invention by using the semiconductor processing technique. The relief valve of the present invention is manufactured by finally releasing a valve member after a step of fabricating a fluid inlet and a valve seat in a first silicon wafer, a step of fabricating a diaphragm and a fluid outlet in a second silicon wafer, and a step of joining the first silicon wafer and the second silicon wafer.

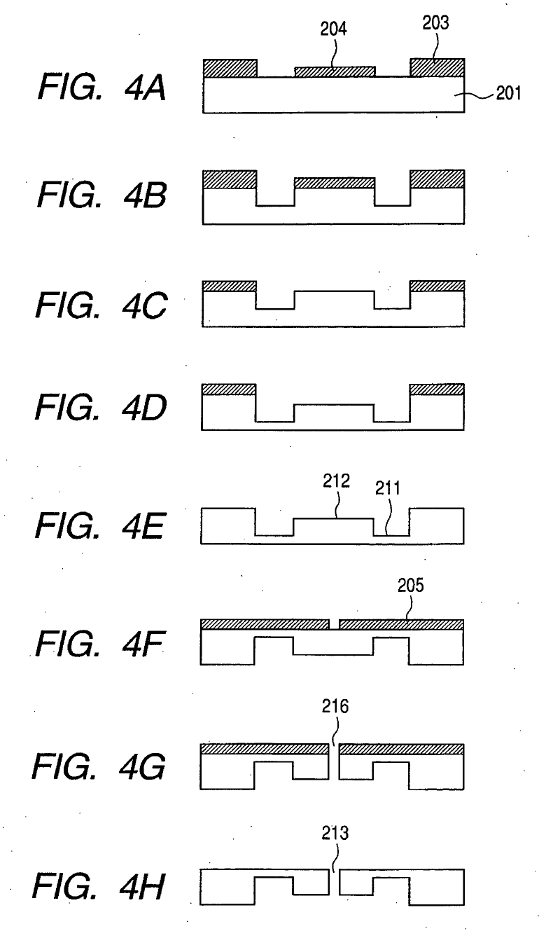

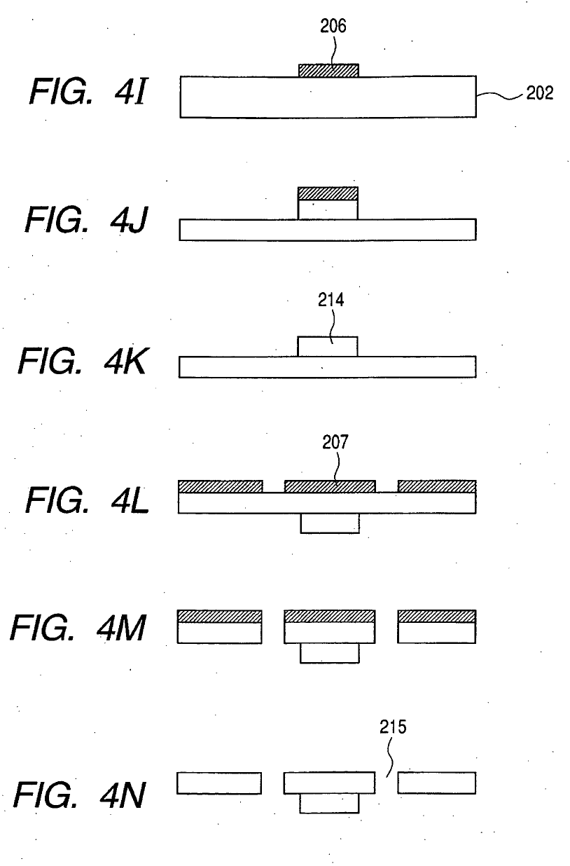

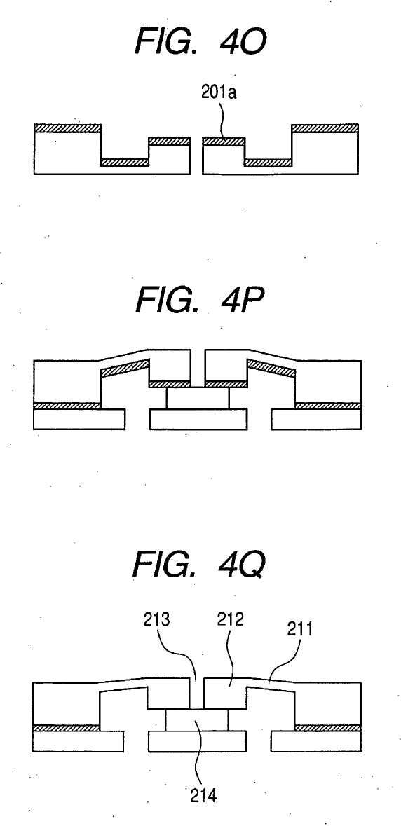

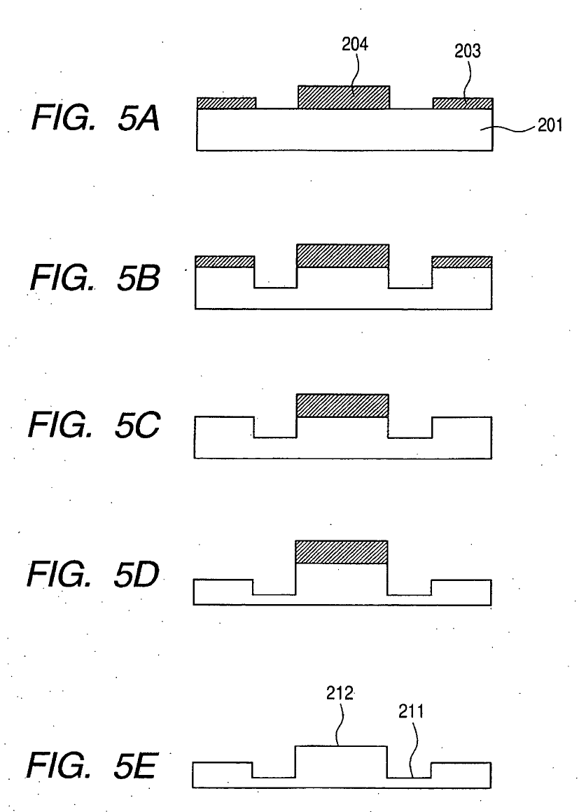

FIGS. 4A to 4Q are process diagrams showing a method of manufacturing a relief valve according to Example 1 of the present invention. The method of manufacturing the relief valve according to the present invention will be described.

The first step shown in FIG. 4A is a step of forming a mask of the diaphragm and the valve member in the first silicon wafer. A both-side polished silicon wafer 201 having a thickness of 300 μm is used for the wafer. First, two aluminum masks are sequentially patterned on the silicon wafer 201. A photoresist made by Shipley Corp., trade name S1805, is used as a first aluminum mask 203 to pattern a mask for forming a diaphragm 211 and a valve member 212. Further, a second aluminum mask 204 is formed thereon by vacuum deposition, and is patterned. Alternatively, it is possible to use the mask material made of a silicon oxide film or a thick photoresist film.

In the second step shown in FIG. 4B, a diaphragm 211 is formed. A silicon wafer is etched by 150 μm vertically by reactive ion etching (ICP-RIE etching).

In the third step shown in FIG. 4C, only the second aluminum mask 204 is removed by wet etching while etching time is controlled.

In the fourth step shown in FIG. 4D, the silicon wafer is etched by 125 μm vertically with the residual mask by the ICP-RIE etching. As a result, the silicon wafer portion having a thickness of 25 μm remains, and forms the diaphragm 211. Also, the center portion has a thickness of 175 μm, and forms the valve member 212.

In the fifth step shown in FIG. 4E, the aluminum mask is removed by wet etching.

In the sixth step shown in FIG. 4F, a mask 205 for formation of the flow path is formed. Aluminum is vacuum-deposited on a back surface of the silicon wafer 201, and then patterned by using the photoresist to form a mask 205 for formation of the flow path.

In a seventh step shown in FIG. 4G, the flow path is formed. The silicon wafer is etched vertically by the ICP-RIE etching to form a through-hole 216 having a diameter of 500 μm.

In the eighth step shown in FIG. 4H, the aluminum mask is removed by wet etching.

In the ninth step shown in FIG. 4I, a mask for forming the valve seat in the second silicon wafer 202 is formed. Aluminum is vacuum-deposited on the surface of the silicon wafer 202, and then patterned by using the photoresist to form a mask 206.

In the tenth step shown in FIG. 4J, a valve seat 214 is formed. The silicon wafer is etched vertically by the ICP-RIE etching. A silicon wafer having a thickness of 300 μm is used for the silicon wafer, and is etched by 150 μm. The initial bending of the diaphragms after bonding is determined according to the amount of etching in this situation. In this example, the initial bending is 25 μm.

In the eleventh step shown in FIG. 4K, the aluminum mask is removed by the wet etching.

In the twelfth step shown in FIG. 4L, a mask for forming the fluid inlet is formed. Aluminum is vapor-deposited on a back surface of the silicon wafer 202, and then patterned by using the photoresist 207.

In the thirteenth step shown in FIG. 4M, a fluid inlet 215 is formed. The silicon wafer is etched vertically by the ICP-RIE etching (reactive ion etching) to form four through-holes having a diameter of 300 μm in the diameter.

In the fourteenth step shown in FIG. 4N, the aluminum mask is removed by wet etching.

In thea fifteenth step shown in FIG. 4O, the front surface of the first silicon wafer 201 is oxidized to form a first oxidized silicon wafer 201a. The surface of the silicon wafer is oxidized in the thickness of 1 μm by thermal oxidation.

In the sixteenth step shown in FIG. 4P, the first silicon wafer 201 and the second silicon wafer 202 are bonded together. After those two silicon wafers are positioned by infrared rays to be superimposed on each other, the bonded wafer is held under a pressure of 450 kPa (about 4.5 atm) for 10 minutes. After that, the sample is heated at 1100° C. for three hours and held for four hours, and then annealed by natural cooling.

In the seventeenth step shown in FIG. 4Q, the valve member 212 is released. The length of 25 μm is side-etched by hydrofluoric acid.

With the above steps, the relief valve of the present invention is formed.

In those steps, the ICP-RIE can be replaced with anisotropic etching by KOH, TMAH, or the like.

Also, an SOI wafer in which the thickness of a handle layer or a device layer is equal to the height of the valve seat is used for the first silicon wafer, thereby making it possible to reduce an error in the valve seat height, and also making it possible to further reduce a variation in the set pressure.

An SOI wafer in which the thickness of a handle layer or a device layer is equal to the thickness of the diaphragm is used for the second silicon wafer, thereby making it possible to use a silicon oxidized layer as an etch stop layer of the etching, and also making it possible to form a uniform diaphragm having no variation in thickness.

In the bonding step of the respective silicon wafers, the crystal faces of the respective wafers are displaced, thereby making it possible to improve the mechanical strength of the entire valve.

In a substrate and a semiconductor silicon wafer, in a case where a gap between the substrate surface and the semiconductor silicon wafer is sufficiently small, and no leakage occurs, it is also possible to omit the bonding step as the sixteenth step. In this situation, the fourteenth film-forming step for forming a sacrifice layer, and the seventeenth releasing step are unnecessary.

Further, in the ninth step, it is also possible that the silicon wafer is not reversed, and a mask is coated on the front surface of the wafer to be etched.

A shape memory alloy film such as TiNi or a thin film having a residual stress is formed on the diaphragm surface by sputtering, or the diaphragm surface is modified by oxidizing or nitriding, or is doped with boron or phosphor, thereby making it possible to bend the diaphragm. As a result, the valve is precompressed, thereby making it possible to change the pressure for opening or closing the valve. In this case, the sixth to eighth steps may be omitted or employed together.

In order to improve the sealing property of the relief valve, a step of coating the relief valve surface may be added. The coating may be made of polyparaxylylene, polymonochloroxylylene, or the like. It is preferable that the coating is made of an elastic material having high sealing property, particularly, a material for forming a layer by vapor deposition. The coating material of this type is, for example, parylene. Parylene 026 (trade name, made by Parylene Japan K. K.) is coated in a thickness of 1 to 2 μm on the surface of the valve.

Other coating materials include CYTOP (registered trademark) or PTFE (polytetrafluoroethylene). For example, an RIE (reactive ion etching) apparatus can be employed for coating of PTFE.

Further, a step of etching the relief valve surface may be added before the coating step in order to improve the adhesion of the coating material, and cancel out the thickened portions of respective members which are attributable to coating. For example, XeF₂ gas is used for the etching. The use of the gas allows the coating to be etched isotropically, and also allows the surface to be roughened. The amount of etching is determined according to a balance of the subsequent coating thickness.

As another method of improving the sealing property between the valve seat and the valve member, it is effective that a contact area of the valve member with the valve seat is reduced, and a surface pressure of the sealing surface is increased. The increase in surface pressure can be achieved by roughening at least one surface of the valve seat or the valve member, for example, with XeF₂ gas.

It is also effective that ring-shaped concave and convex are formed on the valve member as shown in FIGS. 11A and 11B. In the formation of the ring-shaped structure, the vertical etching by the ICP-RIE, the isotropic etching with KOH or TMAH, or the reflow of the photoresist may be used.

The above ring-shaped concave and convex may be formed on the valve seat.

Also, the coating step is conducted in a state where the diaphragm of the relief valve is pushed up, and the relief valve is opened, thereby making it possible to prevent the valve member and the valve seat from adhering to each other by the coating material.

### Example 2

A description will be given of the second method of manufacturing the relief valve of the present invention by using a semiconductor processing technique. The flow of the steps is roughly the same as that of Example 1.

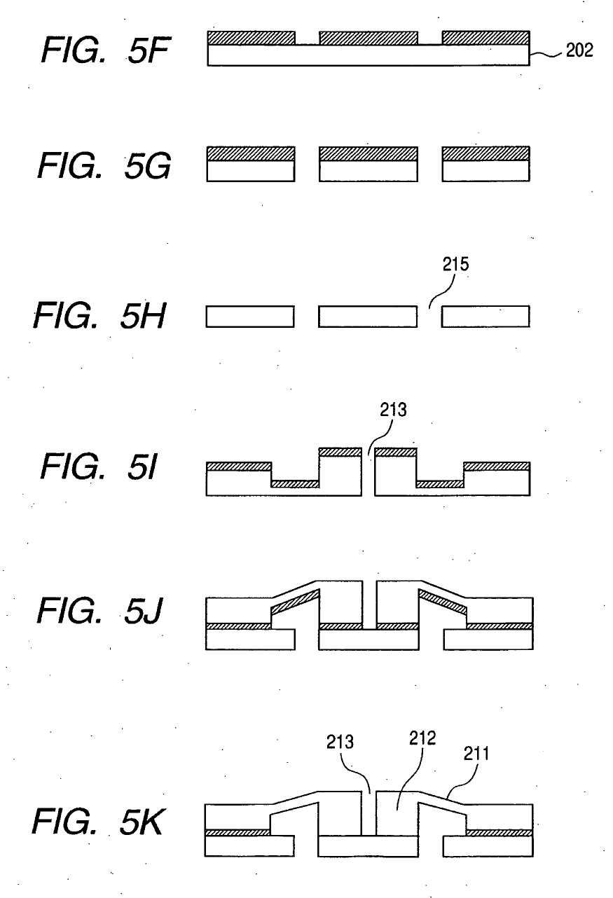

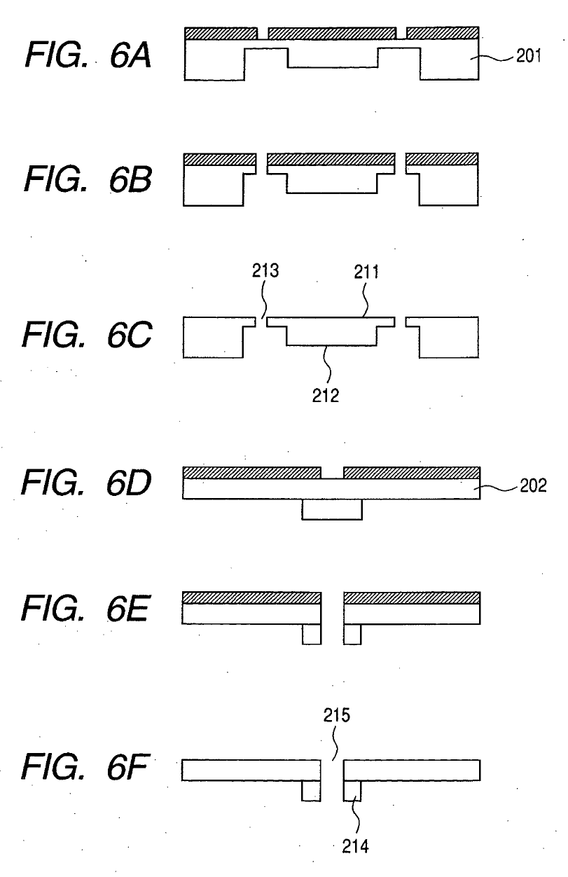

FIGS. 5A to 5Q are step diagrams showing a method of manufacturing a relief valve according to Example 2 of the present invention. In the first step of Example 2, a mask pattern is formed so that a mask 204 is thicker than a mask 203 as shown in FIG. 5A. Subsequently, the second to fifth steps are advanced as shown in FIGS. 5B to SE, the valve member 212 becomes thicker than the surroundings.

After that, the same steps as the sixth to eighth steps of Example 1 are conducted to form a flow path 213. In this case, a mask pattern in the ninth step according to Example 2 is changed as shown in FIG. 5F. Subsequently, a fluid inlet 215 is formed through the tenth and eleventh steps as shown in FIG. 5G and FIG. 5H. The twelfth to fourteenth steps of Example 2 are omitted, and the fifteenth to seventeenth steps are conducted to fabricate the relief valve as shown in FIGS. 5I to 5K.

In addition, it is possible that the surface is modified, coated, or subjected to film formation as in Example 1.

### Example 3

A description will be given of the third method of manufacturing the relief valve of the present invention by using the semiconductor processing technique. The flow of the steps is roughly the same as in Example 1.

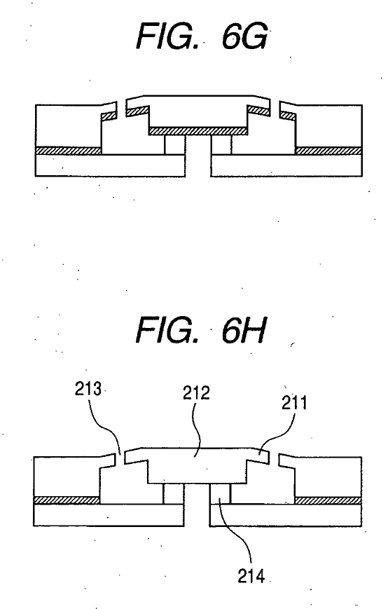

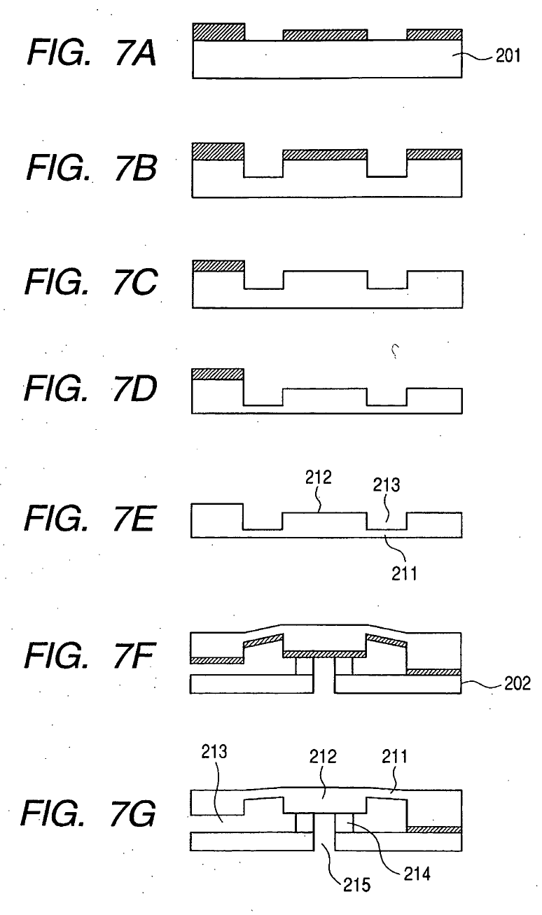

FIGS. 6A to 6H are steps diagrams showing a method of manufacturing a relief valve according to Example 3 of the present invention. In the structure of Example 3, the value seat has a fluid inlet, and the diaphragm has a flow path.

The first to fifth steps of Example 1 are conducted to form a diaphragm portion. Then, the mask pattern in the sixth step is changed as shown in FIG. 6A, and subsequently the seventh and eighth steps are conducted as shown in FIGS. 6B and 6C, to thereby form a flow path in the diaphragm 211. The ninth to eleventh steps of Example 2 are first conducted on the second silicon wafer, and the mask pattern in the twelfth step is changed as shown in FIG. 6D, to thereby form the fluid inlet 215 in the valve seat 214 in the thirteenth and fourteenth steps as shown in FIGS. 6E and 6F. In addition, the fifteenth to seventeenth steps of Example 1 are advanced as shown in FIGS. 6G and 6H, to thereby complete the relief valve.

Further, it is possible that the surface is modified, coated, or subjected to film formation as in Example 1.

It is also possible that the initial bending is given to the diaphragm 211 by making the valve member thicker than the surroundings as in Example 2.

### Example 4

A description will be given of the fourth method of manufacturing the relief valve of the present invention by using the semiconductor processing technique. The flow of the steps is roughly the same as that of Example 1.

FIGS. 7A to 7G are step diagrams showing a method of manufacturing a relief valve according to Example 4 of the present invention. In the structure of Example 4, the value seat has a fluid inlet, and a flow path is formed outside the diaphragm.

The second aluminum mask pattern in the first step of Example 1 is changed as shown in FIG. 7A. Subsequently, the second to fifth steps of Example 1 are advanced as shown in FIGS. 7B to 7E to form the diaphragm 211 as well as the flow path 213. Then, the second silicon wafer is processed in the same manner as in the ninth to fourteenth steps of Example 3. After that, the fifteenth to seventeenth steps of Example 1 are advanced as shown in FIGS. 7F and 7G to complete the relief valve.

Furthermore, it is possible that the surface is modified, coated, or subjected to film formation as in Example 1.

It is also possible that the initial bending is given to the diaphragm 211 by making the valve member thicker than the surroundings as in Example 2.

### Example 5

A description will be given of a case in which the relief valve of the present invention is mounted on a small-sized fuel cell.

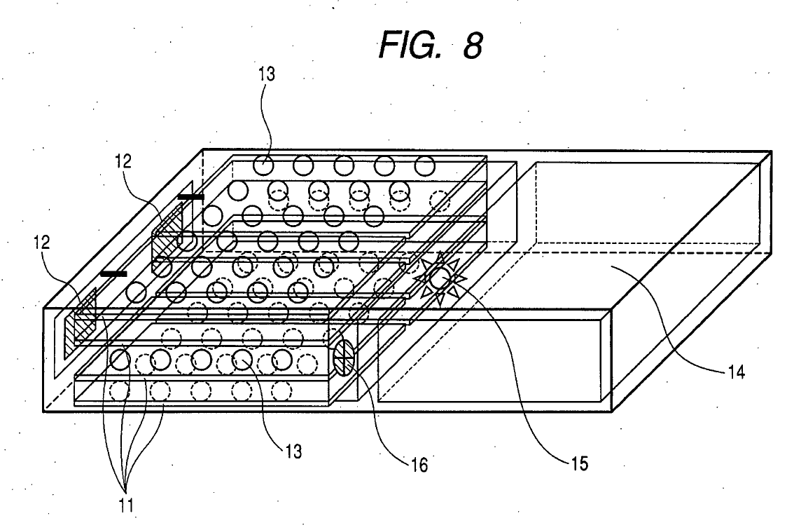

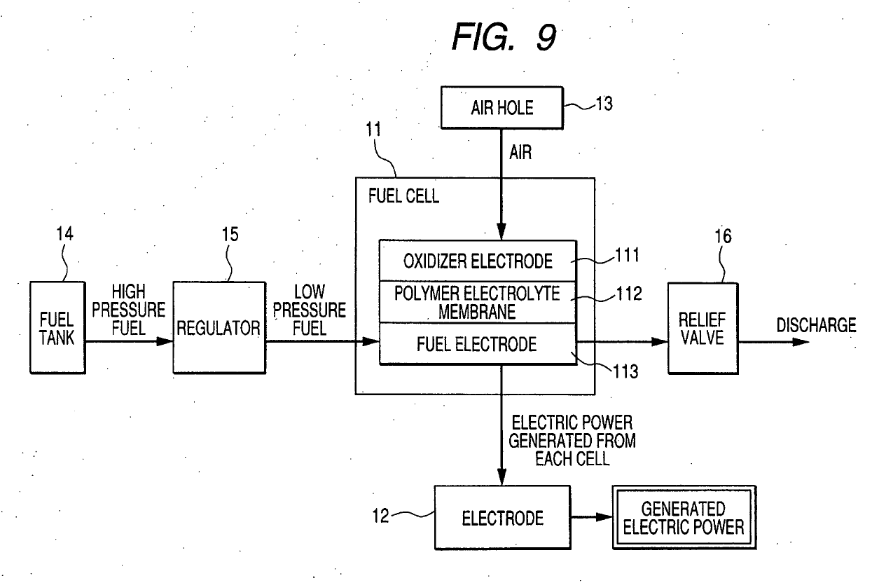

FIG. 8 is a perspective view showing the overview of the fuel cell according to the present invention. FIG. 9 is a schematic diagram showing a system of the fuel cell according to the present invention.

The outer dimensions of the fuel cell are 50 mm×30 mm×10 mm, which are substantially the same as those of a lithium ion battery that is normally used in a compact digital camera. Because the fuel cell of the present invention is small in size and not integrated with the camera, the fuel cell is so shaped as to be incorporated into a mobile instrument. Because the fuel cell of the present invention takes in oxygen used for reaction as an oxidizer from the external air, the fuel cell has air holes 13 for taking in the external air on upper and lower surfaces as well as side surfaces. The air holes also function to escape the generated water as steam, or escape a heat generated due to the reaction to the external. Also, there is an electrode 12 for taking out electricity at one side surface. The interior of the cell includes a fuel cell unit 11 having a polymer electrolyte membrane 112, an oxidizer electrode 111 and a fuel electrode 113; a fuel tank 14 for storing fuel therein; a regulator 15 that connects the fuel tank to the fuel electrodes of the respective cells, and controls the flow rate of the fuel; and a relief valve 16 for emitting the fuel to the external in a case where a pressure within the flow path becomes high.

The fuel tank 14 will be described. The interior of the tank is filled with a metal hydride that is capable of occluding hydrogen therein. Since the pressure resistance of the polymer electrolyte membrane which is used for the fuel cell is 0.3 to 0.5 MPa, a differential pressure from the external air needs to be about 0.1 MPa.

As the metal hydride having such a characteristic that the relief pressure of hydrogen is 0.2 MPa at a room temperature, there is, for example, LaNi₅. When it is assumed that the volume of the fuel tank is a half of the volume of the entire fuel cell, and the wall thickness of the tank is 1 mm, and the tank material is titanium, the weight of the fuel tank becomes about 50 g, and the fuel tank volume is 5.2 cm³. Since LaNi₅ is capable of absorbing and desorbing hydrogen of 1.1 wt. % per weight thereof, the amount of hydrogen stored in the fuel tank is 0.4 g, and the power energy that can be generated is about 11.3 W·hr, which is about four times as large as that of the conventional lithium ion battery.

On the other hand, in a case where the release pressure of hydrogen exceeds 0.2 MPa at the room temperature, it is necessary to provide the regulator 15 for reducing a pressure between the fuel tank 14 and the fuel electrode 113. Dissociation pressures at the respective temperatures of LaNi₅ are shown in Table 4. Hydrogen stored in the tank is reduced in the pressure, and then supplied to the fuel electrode 113. Also, the external air is supplied to the oxidizer electrode 111 from the air hole 13. The electricity that has been generated by the fuel cell unit is supplied to the small-sized electric instrument from the electrode 12.

However, there is a case in which the pressure within the fuel electrode chamber is temporarily increased according to the response characteristic of the regulator. In this case, the relief valve 16 disposed within the fuel flow path operates, thereby making it possible to prevent the increase of a pressure within the fuel electrode chamber.

For example, in a case of fabricating the relief valve with the use of the conventional mechanical processing technique, the relief valve is structured as shown in FIGS. 3A to 3C. The diaphragm 104 is made of silicone rubber, 5 mm in diameter, and 0.8 mm in thickness, the diameter of the flow path 105 is 0.5 mm, and the displacement of the diaphragm 104 by the valve seat 103 is set to be 0.07 mm. In this case, the relief valve 104 is opened in a case where the pressure within the fuel electrode chamber exceeds 30 kPaG. When the pressure within the fuel electrode chamber is in a range of from 50 kPaG to 100 kPaG, the flow rate is about 270 to 390 sccm, thereby making it possible to release the pressure within the fuel electrode chamber without damaging the fuel cell. Also, because the valve per se is not damaged up to about 900 kPaG, the valve has a sufficient strength. Also, the natural frequency is about 670 kHz, which produces a satisfactory response speed.

On the other hand, in a case of fabricating the relief valve by using the semiconductor processing technique, the relief valve has the structure shown in FIG. 4Q, the diaphragm 211 is made of silicone, 5 mm in diameter, 0.025 mm in thickness, the diameter of the flow path 213 is 0.5 mm, and the displacement of the diaphragm by the valve seat 214 is set to be 0.007 mm. In this case, the relief valve is opened in a case where the pressure within the fuel electrode chamber exceeds 30 kPaG. When the pressure within the fuel electrode chamber is in a range of from 50 kPaG to 100 kPaG, the flow rate is about 29 to 390 sccm, thereby making it possible to release the pressure within the fuel electrode chamber without damaging the fuel cell. Also, because the valve per se is not damaged up to about 900 kPaG, the valve has a sufficient strength. Also, the natural frequency is about 8.6 MHz, which produces a satisfactory response speed.

In particular, when the flow path resistance in the relief valve is so designed as to be made smaller than the resistance of each flow path on other portions in the fuel cell, the pressure within the flow path can be prevented from being excessively increased.

TABLE 4

Temperature (° C.)

| | 20 | 25 | 50 | 100 |
|---|---|---|---|---|
| Dissociation | 0.15 | 0.20 | 0.40 | 2.0 |
| pressure (Mpa) | | | | |

### Example 6

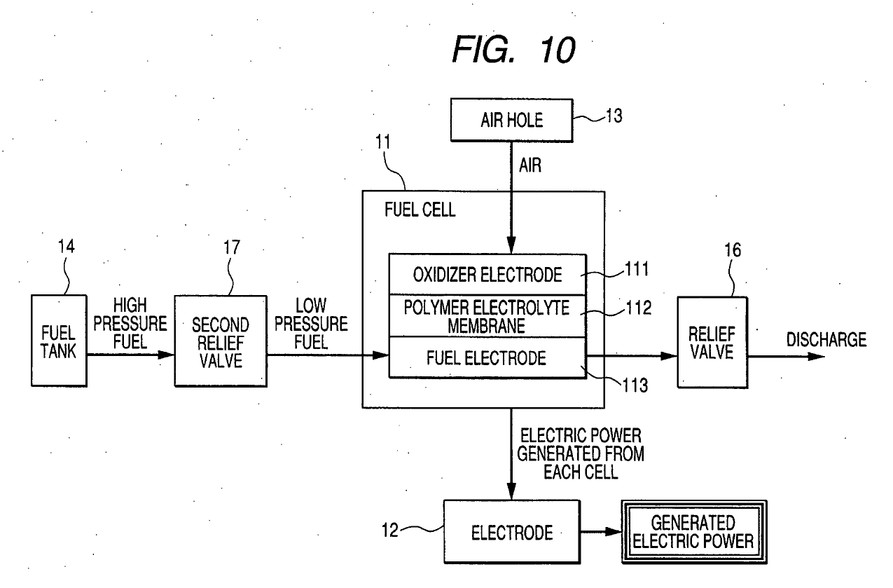

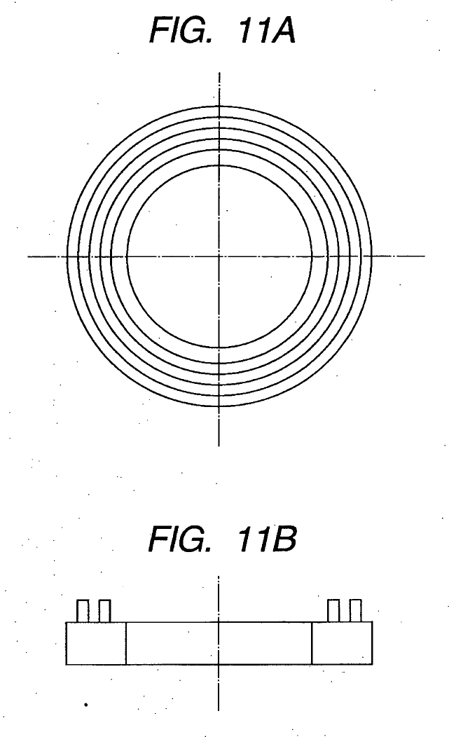

A description will be given of Example 6 as the second example in which the relief value of the present invention is mounted on a small-sized fuel cell. FIG. 10 is a schematic diagram showing a fuel cell system according to Example 6. In this system, the second relief valve 17 is used in place of the regulator 15 in Example 5. A set pressure of the second relief valve 17 is lower than the set pressure of the first relief valve 16. Further, in a case where the pressure of the fuel tank 14 at the normal use temperature is supplied to the inlet, the pressure at the outlet is adjusted to a pressure optimum to the driving of the fuel cell. As a result, when the pressure within the fuel tank 14 is within a normal range, a fuel having a pressure optimum to the power generation is supplied to the fuel electrode 113. Further, in a case where the pressure within the fuel tank 14 abnormally increases, the first relief valve 16 is opened, to thereby relieve the pressure within the fuel flow path. Accordingly, the pressure within the fuel flow path can be kept in an optimum state.

As described above, the relief valve of the present invention has a simple structure, and is therefore readily made smaller in size. Also, the relief valve made of a semiconductor wafer according to the present invention can be made remarkably smaller by using the semiconductor processing technique. In addition, in a case where the relief valve of the present invention is mounted on the small-sized fuel cell, the pressure within the fuel flow path can be prevented from abnormally increasing to damage the fuel cell.

This application claims priority from Japanese Patent Application No. 2005-222099 filed on Jul. 29, 2005, which is hereby incorporated by reference herein.

What is claimed is:

1. A relief valve for pressure adjustment, which is made of a semiconductor wafer and operates in a case where a pressure at a fluid inlet is higher than a pressure at a fluid outlet by a pressure higher than a set pressure value, comprising:
a flow path communicating the fluid inlet with the fluid outlet; and
a diaphragm for opening and closing the flow path by deformation of the diaphragm utilizing a differential pressure between the fluid inlet and the fluid outlet.

2. A relief valve according to claim 1, wherein the flow path is provided such that the flow path penetrates the diaphragm or a support portion for supporting the diaphragm.

3. A relief valve according to claim 2, wherein the flow path penetrates the diaphragm, the diaphragm and a valve seat are provided so as to be in contact with each other, and a contact state and a non-contact state of the diaphragm with the valve seat are switched by deformation of the diaphragm.

4. A relief valve according to claim 2, wherein the flow path penetrates the support portion for supporting the diaphragm, the support portion and a valve seat are provided to be in contact with each other, and a contact state and a non-contact state of the support portion with the valve seat are switched by a deformation of the diaphragm.

5. A relief valve according to claim 4, wherein the support portion for supporting the diaphragm is a valve member.

6. A relief valve according to claim 2, wherein the flow path penetrates a part of the support portion for supporting the diaphragm, another part of the support portion and a valve seat are provided so as to be in contact with each other, and a contact state and a non-contact state of the another part of the support portion with the valve seat are switched by deformation of the diaphragm.

7. A relief valve according to claim 6, wherein the another part of the support portion for supporting the diaphragm is a valve member.

8. A relief valve according to claim 1, wherein the differential pressure between the fluid inlet and the fluid outlet is adjusted by causing bending or stress in the diaphragm.

9. A method of manufacturing a relief valve for pressure adjustment which comprises a flow path communicating a fluid inlet with a fluid outlet, and a diaphragm for opening and closing the flow path by deformation utilizing a differential pressure between the fluid inlet and the fluid outlet, the relief valve operating in a case where a pressure at the fluid inlet is higher than a pressure at the fluid outlet by a pressure high than a set pressure value, the method comprising the steps of:
forming the diaphragm and the flow path in a semiconductor wafer; and
forming the flow path in a substrate.

10. A method of manufacturing the relief valve according to claim 9, further comprising the step of forming a valve member in the semiconductor wafer.

11. A method of manufacturing the relief valve according to claim 9, further comprising the step of forming a valve seat in the substrate.

12. A method of manufacturing the relief valve according to claim 9, further comprising the step of bonding the semiconductor wafer and the substrate.

13. A method of manufacturing the relief valve according to claim 12, further comprising the steps of:
forming a sacrifice layer before bonding the semiconductor wafer and the substrate; and
removing the sacrifice layer after bonding the semiconductor wafer and the substrate.

14. A method of manufacturing the relief valve according to claim 9, further comprising the step of forming a thin film on a surface of the diaphragm.

15. A method of manufacturing the relief valve according to claim 9, further comprising the step of modifying or coating the surface of the relief valve and coating of the surface of the relief valve.

16. A method of manufacturing the relief valve according to claim 9, wherein the substrate is made of a semiconductor wafer.

17. A fuel cell, comprising the relief valve according to any one of claims 1 to 8.
